(19) United States
(12) Patent Application Publication
(10) Pub. No.: US 2011/0169757 A1
(43) Pub. Date: Jul. 14, 2011

(54) PROACTIVE IMAGE REMINDING AND SELECTION METHOD

(76) Inventors: Graham R. Kiddle, Cambridgeshire (GB); John D. Piper, Cambridgeshire (GB); Alan W. Payne, Cambridge (GB); Steven Wall, Surrey (GB); David Frohlich, Guildford Surrey (GB)

(21) Appl. No.: 12/989,139

(22) PCT Filed: Mar. 31, 2009
(86) PCT No.: PCT/EP09/53831

§ 371 Date: Mar. 17, 2011

(30) Foreign Application Priority Data
Apr. 24, 2008 (GB) 0807441.1

(51) Int. Cl. G06F 3/041; G06K 9/68

(52) U.S. Cl. 345/173; 382/218

(57) ABSTRACT

The invention is related to an image selection method comprising the following steps: a) automatically and randomly selecting (100) at least one, so-called, reminder digital image (108), amongst a collection (102) of digital images, b) automatically selecting at least one subset (130, 130a) of, so-called, linked digital images amongst the collection of images, the linked images being selected based on a similarity computation with the randomly selected reminder image, c) temporarily displaying (104) the reminder image on a display screen and stetting (106) a first user interface in an interaction detection mode whilst the reminder image is displayed, d) in response to a user interaction with the first interface whilst the reminder image is displayed, displaying simultaneously at least part of the subset of linked images determined in step b) and setting a second user interface in a selection mode in which a user can select at least one image amongst the displayed subset of linked images, e) in response to the user selection (150) on the second user interface, making the data of the at least one selected linked image available (170) to an image processing, f) iterating with a new random selection of step a).

The present invention is related to an image handling method providing access suggestions to images of an image collection. In particular the method aims to provide an access point to images that a user does not know about or that a user has forgotten. The method also aims to offer easy display, print and image exchange opportunities. The method may find applications in different kinds of multimedia devices having a display screen, such as printers, personal computers, mobile phones or television. It is however particularly designed for use with a digital photo frame.

A digital photo frame or digital photo album is a fixed or transportable viewing device. It usually has a quite large display screen and is associated to an external, internal or even a remote memory. The memory is used to store a collection of digital image data and possibly other digital multimedia content. The digital photo frames are specially designed to display still images, or sequences of still images. Some existing hand-held multimedia devices, cellular phones or organizers can be used occasionally as photo frames.

### BACKGROUND OF THE INVENTION

The invention results from the observation that many digital images in an image collection tend to remain unused because the users of the image collection do not remember these images and fail to have an easy access path to the images. Such images are in a way “lost”. The risk of an image being lost, increases with the size of the image collection but also depends on the efficiency of the image browsers used to navigate through the collection, the frequency which people access and the subsequent familiarity they have with their images. Many image browsers require a given image labeling or classification. An image that is not classified or not correctly classified will very likely become lost in the collection. It has further been observed that the probability of use of an image, either for displaying, printing or sharing, is rather high at the time the image is captured and stored in an image handling device, but then significantly decreases with time. Older images are often only looked at when there is a particular reason to do so, for example a photo project for a 60^{th} birthday.

A number of ways to deal with large image collections have been explored. These methods typically attempt to provide the user with ways to browse images, to search for specific images and to predict which images may be of interest thus reducing the pool of images to browse.

Amongst the approaches to image browsing, document (1), whose reference is indicated at the end of the present description, proposed a browser based on tiles as far back as 2001. Efforts around techniques for reminding images to have been made in the context of reminders attached to specific events such as birthdays. Reference can be made for example to document (2). The concept of anticipation in digital image systems has received little attention. Document (3) however reports instances of sidetracking behavior during observations of users interacting with either digital photo or music collections. Also document (4) relates several examples of serendipity based on personally significant encounters with randomly selected digital content such as music playback. The references of above cited documents (2), (3) and (4) are also given at the end of the description.

### SUMMARY OF THE INVENTION

In order to reduce the number of “lost” digital images and in order to allow a user to process images buried in large collections of digital images the present invention suggests an interactive image selection method comprising the following steps.
a) automatically and randomly selecting at least one, so-called, reminder digital image, amongst a collection of digital images,
b) automatically selecting a subset of, so-called, linked digital images amongst the collection of images, the linked images of the subset being selected based on a similarity computation with the randomly selected reminder image,
c) temporarily displaying the at least one reminder image on a display screen and setting a first user interface in an interaction detection mode whilst the reminder image is displayed,
d) in response to a user interaction with the first interface whilst the reminder image is displayed, displaying simultaneously at least part of the images of the subset of linked images determined in step b) and setting a second user interface in a selection mode in which a user can select at least one image amongst the displayed subset of linked images,
e) in response to a user selection on the second user interface, making the data of the at least one selected linked image available to an image processing,
f) iterating with a new random selection of step a).

The method can be carried out on many multimedia devices having a display function but still more advantageously on stationary devices having large size screens such as personal computers, or digital photo-frames.

For the sake of simplification, and as far as the context appears explicit, the terms “digital image” are indistinctly used to refer to the semantic content of an image likely to be displayed or printed and to refer to the corresponding digital data or metadata stored in a memory. It is however understood that the term refers to the data as far as an image processing step is concerned and that the term refers to a visible display or print as far as interactions with a user are concerned. The image collection may be all or part of the images stored in a remote, a built in, or a removable memory to which the user has access. The collection may be closed or open to updates.

The selection referred to in step a) corresponds to a non-predictable selection that may encompass perfectly random selection as well as possible semi-random selection. The selection is considered to be semi-random when the selection relates to predetermined parts of the collection of images or when the selection is oriented or weighted, but still non-predictable for the user.

The selection is automatic in the sense that no user choice is involved or required: the choice, as seen from a user, is non-predictable and made by machine. Also the user has no control over the selection.

Thanks to the random selection of the so-called “reminder images” the process offers the possibility that images that have been forgotten, or even unknown to a user are selected. Such images would otherwise not be targeted in a usual browsing process. Another advantage is that the random selection can be made free from existing image categories or image orders that would exist in the image collection.

One or several reminder images may be displayed temporarily on a display screen. Different display presentations and durations may be selected. As an example, a reminder image may have a display size that changes over time, whilst the image is displayed.

The duration of display of the reminder image may be preset or also randomly chosen in a given duration range. The display may however advantageously be a periodic display. Each randomly selected image is then displayed for a given duration such as one minute, one hour, one day etc. and the display may even be scheduled at a given time in the day. As an example, the display of a randomly selected image may be one hour display scheduled at breakfast time.

The display of randomly selected reminder images can also be set as the basic functioning mode of a digital photo-frame.

Whilst the display of the reminder images, a first interface is set in an interaction watching mode. In other words, the interface waits for any low-level interaction of a user in order to detect it. In this mode the user is not required to input data or to make a selection but is just invited to interact, i.e., for instance, to touch a screen, a frame, to move a computer mouse, etc. The interaction is interpreted as a possible user's interest for the randomly selected image that is displayed at the time of interaction. The first interface can be a very simple interface such as a button. It can also be a computer mouse or a touch-screen merely waiting to be touched. It also may be a camera, detecting a somewhat prolonged presence of a user in front of the display screen on which a reminder image is displayed. The latter may be the case for a photo frame attached to a wall.

A important step of the invention is step b). This step determines which selection has to be offered to the user once he has shown some interest in interacting with the first interface.

In a basic embodiment of the invention, especially suitable for an ordered collection of images, the selection step b) could be the selection of a determined range in the ordered images dictated by the rank of the reminder image in that order. As an example, if the images of the collection have a capture time stamp and therefore have an a priori order with respect to the capture time, the so-called similarity computation, could be limited to determining the images of the collection that have been captured in a given time range defined with respect to the capture time of the randomly selected reminder image.

The ordering of the image collection into an a posteriori order can also be part of the similarity computation.

An ordered collection of images can also be a collection in which the images have been previously associated to images categories. The similarity can then result from the fact that a linked image belongs to a same image category as the reminder image.

The use of pre-existing orders or categories, image labels, or image metadata to set up the above mentioned subset of linked images does however not give an equal selection probability for each image of the collection. An image that has not been previously sorted or classified or that has been wrongly classified remains very likely a “lost” image unless being itself picked as a remember image.

In an improvement of the invention, step b) may therefore comprise the sub steps of:
determining at least one type of image feature for the randomly selected reminder image and determining the same type of feature for other, so-called, “test images” of the image collection, then
comparing the image feature of the test images with the feature of the reminder image, and then
selecting amongst the test images, a subset of linked images whose image feature is closest to the reminder image.

All or only part of the images contained in the image collection may be used as the test images. The number of test images retained for the subset of “linked images” may be set by a fixed or variable comparison threshold. Especially the threshold can be variable with respect to the display capability of a screen used to display the linked images in subsequent step d).

The above mentioned image feature may be at least one feature amongst capture time/date of the images, a semantic content of the images, a preset metadata attached to the images, or even all or part of the digital image data itself. As an example, if the feature is the image data itself, the similarity computation may be carried out by a cross-correlation calculation of each of the test images data with the data of the chosen reminder image. The result of each cross-correlation can then be compared to a threshold to determine whether the corresponding test image has to be part of the selected subset of “linked images”.

Still as an example, the type of feature may be human faces present in the images. The reminder images as well as the test images are then analyzed by a face detection algorithm. If a given face is identified as a feature of the reminder image then this face may be compared using a face recognition algorithm with faces possibly identified in the other test images. The subset of linked images can then be selected as all or part of the images in which the same face has been identified.

After having been automatically selected based on the similarity computation, all or at least part of the subset of linked images are simultaneously displayed on a display screen. The images are displayed, for example in the form of a grid of images or thumbnail images.

The second user interface is then set in a selection mode allowing the user to select one or more images amongst the displayed linked images. The first and second user interfaces may be a single interface set in different modes whilst the process. In another embodiment, the first and second interfaces may also be interfaces of different devices.

If several reminder images were displayed simultaneously at the time of the first user interaction, linked images can be determined for some or all the reminder images present at the time of interaction. The user may also be offered the option to make a first selection between a small number of simultaneously present reminder images at the time of his/her first interaction, or just after this first interaction and before the selection amongst the linked images.

The selection mode amongst the linked images is no longer a mere interaction detection. The second user interface may be a different interface or the same interface as the first one, except the fact that it is no longer used in a mere interaction detection mode but in a selection mode.

The second interface may comprise a computer mouse, a keyboard or even preferably a touch screen having sensitive areas corresponding to the location of each of the displayed linked images.

In this mode, the displayed linked images are used as selection icons for selecting images and in turn the image data that has to be processed.

The subsequent step in which the image data is made available for processing may include the use or the processing of the selected data directly within the device running the selection method. Making the data available may also include sending the image data to a remote processing device. The term processing is here understood broadly. The processing may especially include operations such as image printing, image sharing, image modification, image storage, sending image to a remote electronic address via a communication network etc.

After this task has been performed, the process may be iterated with a new random selection of one or more other reminder images. The iteration may also result at any time upon a user control input. The iteration may also be triggered automatically when a given time has lapsed without any user input or interaction or when the time of the temporarily display of the reminder images is over.

The invention also suggests a digital photo frame that includes a processing unit running software instructions suitable for performing the above method. The digital photo frame has local or remote access to a memory storing all or part of an image collection.

Other characteristics and advantages of the invention will appear in the following description with reference to the figures in the appended drawings. This description is given as a non-limiting illustration.

### BRIEF DESCRIPTION OF THE DRAWINGS

FIG. 1 is a flow chart illustrating an image selection and processing method corresponding to the invention.

FIG. 2 is a simplified and schematic view of a digital photo frame according to the invention.

### DETAILED DESCRIPTION OF THE INVENTION

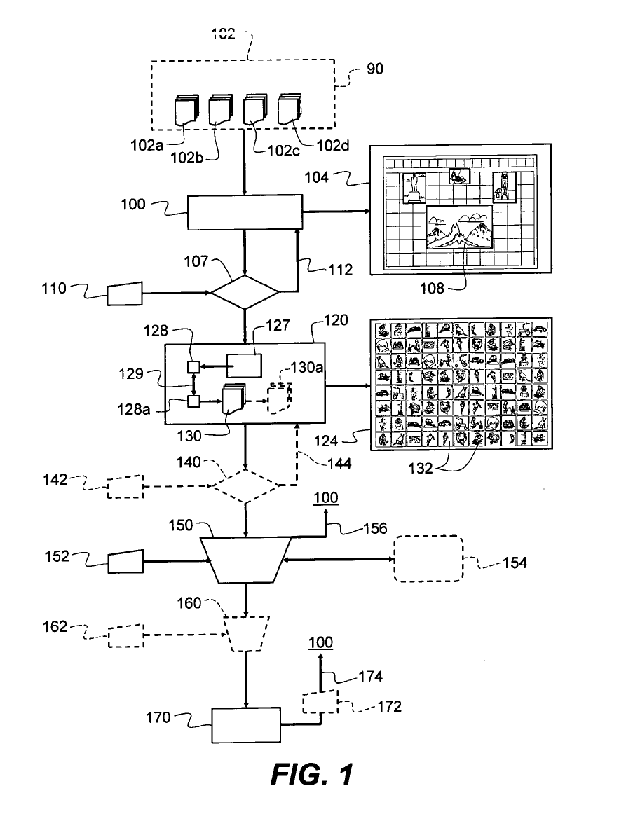

The flowchart of FIG. 1 shows a first step 100 in which reminder images are selected in a way unpredictable to the user from a collection 102 of digital images which are schematically represented as image data files.

An optional preliminary step 90, which can be performed automatically or based on user input, comprises the sorting and ordering of the images in the collection 102. In particular the images data may comprise metadata indicative of the capture time and date, and the images may be ordered chronologically. The images may also be sorted and arranged in image categories 102a, 102b, 102c, 102d chosen by a user. The categories correspond for example to capture situations such as: “vacation”, “birthday”, “new year” etc.

Turning back to the selection step 100 of the reminder image, several options are open. The selection can be made from the whole collection 102 in a random way. The selection can also be semi-random with the choice of image weighted between the different image categories 102a, 102b, 102 c, 102d and random within each given category, so that the choice appears non-predictable for the user. The selection can still be semi random with multiple image reminders, selected from different parts of the image collection.

The selection step is followed by a display 104 of the randomly selected reminder images and by the concomitant setting of a first interface in a user interaction detection mode 107.

In the example of FIG. 1 several reminder images 108 are simultaneously displayed with variable size. The display size of each reminder image changes as a function of the time from the instant a reminder appears on a display screen to the instant it disappears. A opportunity may be given to the user to select other presentations of the reminder images. The system might also choose a different presentation which could change with each new reminder image.

When several reminder images are simultaneously displayed, the first interface may also be set in a mode allowing the user not only to show his/her interest by any interaction but also possibly make a first basic choice between the few displayed reminder images. The main function however remains to detect the user's interest by an interaction that is preferably as easy as possible.

As long as no interaction is detected, the display of the reminder image goes on. This is shown by arrow 112. If the preset display time of a reminder images is over, the display of this image is replaced by the display of a next randomly selected reminder images.

A user interaction is shown on FIG. 1 with reference 110. If this interaction is detected, then a next step 120 of determining linked images is triggered. A display 124 of the linked images is also triggered and a second interface is set in a selection mode 140 in which a user can select one or more amongst the displayed linked images. The reminder image itself for which the user has shown interest by his first interaction may of course be part of the subset of linked images that is subsequently displayed and offered to the user' selection 142.

The step 120 of determining a subset of linked images can take place or begin even before the detection of the user interaction 110. As soon as a reminder image has been automatically selected, the similarity computation can be initiated. In other words, the subset of linked images can be made ready, but not displayed, before the detection of the first interaction. The preparation of the subset of linked images at an early stage is suitable if the similarity computation requires high computer time and resources.

The similarity computation can even begin, at least in part, before the selection of the reminder image. This is the case when the similarity computation is based on the preliminary sorting or ordering step 90. The ordering step 90 can then be considered as part of the similarity computation, although it may be useful for other purposes.

In the example of FIG. 1, for each of the reminder images one or several image features 128 are determined in a computation step 127 and a subset 130 of linked images having the same or approaching image features 128a is selected. The selection can be made by a comparison of image features 129. Several subsets 130, 130a of linked images may be determined for each reminder image. Different sets of linked images may be selected based on different types of image features.

The criteria for selecting the linked images can be preset or be variable so as to select for each subset 130, 130a, number of linked images in concordance with the display capability of the screen used for display.

A simple example can be given in the case where the image feature taken for similarity computation is the capture time. A first time range around the capture time of the reminder image may be taken as a selection criterion for the linked images. If this time range encompasses a number of linked images that would be much greater than a number of images that can be displayed simultaneously with a sufficient resolution, then the time range can be narrowed. The narrowed time range then constitutes a more restrictive criterion. A smaller time range will result in less linked images being selected and a greater time range will result in more linked images being selected. In a comparable way, a criterion can be adjusted each time the computed image feature is a scalable or metric value.

As shown on FIG. 1, the linked images, corresponding to one or more reminder images, can be displayed as thumbnail images 132.

The reference 140 indicates an optional choice that may allow the user to swap the displayed subset of linked images. The swap of the displayed linked images can be triggered by an input 142 such as, for example, the depression of a swap button or a mouse click, etc. In this case, and if available, another subset of linked images is displayed. This alternative subset of linked images may be selected based on another image feature of the same reminder image. The alternative subset of linked images may also correspond to another reminder image that was displayed at the time of the first user interaction.

Taking an example from FIG. 1, the user's input 142 may be used to swap from the first subset of linked images 130 to the second subset of linked images 130a. A comparable swap input may still be used to scroll through a subset of images comprising a larger number of linked images than the display screen allows to display simultaneously. This then avoids the restriction of the number of selected linked images to the display capability of the screen.

An arrow 144 represents the selection of another or an additional subset of images upon swap and return to the display 124 of that other subset of linked images.

A subsequent selection of one or several displayed linked images implies a user input 152 that is made on the second interface that has been set in the selection mode 150 as mentioned above. As far as the interface is a touch screen the displayed linked images can be directly used as selection icons that are triggered by touching.

Optionally, a linked image selected by the user in step 152 can be used as a starting point for further browsing through the image collection. This option for a more sophisticated selection is indicated in dotted lines with reference 154. The image data of the image selected in step 150, or possibly in step 154, can then be used for further local processing or sent to a remote processing device.

The way the selected image data are to be processed may be predetermined. It is however also possible to add in the process a still further selection option 160, where upon user input 162, the type of processing or a processing device may be selected. This selection option 160 may happen earlier in the process. It can, for example, follow the first interaction 110 of the user with the first interface.

A box 170 represents the step in which the digital data of the previously selected image is made available for processing. This step may additionally include a local use of the image or the sending of the selected image data to a remote device or processing facility. The data can be sent, for example, via a communication network or transmitted directly in a so-called peer to peer exchange. As examples of a local use, if the process is run on a photo frame the image data processing can be an enlargement of the selected image and its display on the frame for a given duration. The data may also be sent to a remote printer. If the process is directly run on a printer equipped with a monitor screen, then the processing may include the automatic printing of a hard copy of the selected image.

After the data have been sent or processed the method resumes with an iteration at step 100, as shown by an arrow 174. This iteration can be triggered automatically after a preset waiting period or may be triggered at any time upon a user reset input 172.

The same may happen if, after a preset waiting period, no user input 152 is made on the second interface. This is indicated with an arrow 156.

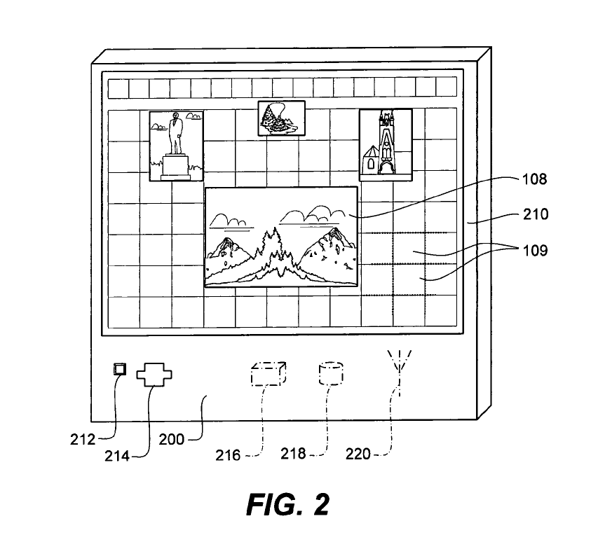

FIG. 2 shows a digital photo frame 200 likely to be used with the above method.

The photo frame comprises a touch screen 210 that is used as a display screen but also as the first and second user interfaces.

In addition to the touch screen the photo frame may comprise a button 212 that can be used as the first user interface to proceed from the reminder image display to the linked images display. Another touchpad 214 may be used to navigate through the displayed linked images that may be arranged as a two dimension grid.

In the illustration of FIG. 2 a certain number of reminder images 108 are displayed on the screen with different size and a location. In the background of the display several thumbnail images 109 corresponding to a set of formerly displayed linked images are also shown with low contrast.

The photo frame may also include a processing unit 216 shown in mixed line, and able to run software instructions to carry out the above described method. The processing unit is connected to the interfaces 212, 214, to the touch screen 210, as well as to a memory 218 storing the image data and metadata.

Reference 220, still in a mixed line, represents in symbolic form an antenna. The symbolic antenna 220 indicates the photo frame is able to communicate remotely and wirelessly to a processing device such as a printer, a mobile phone, a computer or a home TV which are themselves able to communicate remotely with the photo frame. If the data of a selected image are to to be sent to a TV, then the processing of the image data comprises adapting the data to the TV format and displaying the image.

### CITED DOCUMENTS

1) Bederson, B. B. Photomesa; A Zoomable Image Browser Using Quantum Treemaps and Bubblemaps, Copyright ACM (2001) 1-58113-438
2) Sellen, A. J., Murphy, R. L., Bijsmans, J. G. Electronic Reminders Pub US 2003/0002390 A1
3) Bentley, F., Metcalf, C. and Harobe, G. Personal vs. commercial content: The similarities between consumer use of photos and music Proceeding of CHI 06 ACM Press, New York, N.Y., 2006, 667-676
4) Leong, T. W., Howard, S. and Vetere F; Choice: abdicating or exercising Proceedings of CHI '08. ACM Press, New York, N.Y., 2008

1) An image selection method comprising the following steps:
a) automatically and randomly selecting at least one, so-called, reminder digital image, amongst a collection of digital images,
b) automatically selecting at least one subset of, so-called, linked digital images amongst the collection of images, the linked images being selected based on a similarity computation with the randomly selected reminder image,
c) temporarily displaying the reminder image on a display screen and stetting a first user interface in an interaction detection mode whilst the reminder image is displayed,
d) in response to a user interaction with the first interface whilst the reminder image is displayed, displaying simultaneously at least part of the subset of linked images determined in step b) and setting a second user interface in a selection mode in which a user can select at least one image amongst the displayed subset of linked images,
e) in response to the user selection on the second user interface, making the data of the at least one selected linked image available to an image processing,
f) iterating with a new random selection of step a).

2) The method according to claim 1, wherein the first and second user interfaces are a touch screen of a digital photo frame on which images are displayed in steps c) and d).

3) The method according to claim 1, wherein a plurality of reminder images are randomly selected and displayed simultaneously whilst step c).

4) The method according to claim 1, wherein the image collection comprises a plurality of image categories and wherein the reminder images are randomly selected in different image categories.

5) The method according to claim 1 wherein step e) comprises at least one step amongst: printing an image corresponding to the image data, displaying an image corresponding to the image data and sending the image data to at least one image processing device selected amongst: a display screen, a printer, a personal computer, an image browser and/or a multimedia device.

6) The method according to claim 1 wherein step b) is carried out after step c) in response to a user interaction with the first interface.

7) The method according to claim 1, wherein the similarity computation of step b) comprises the step of:
determining at least one type of image feature for the randomly selected reminder image and determining the same type of feature for other, so-called, “test images” of the image collection,
comparing the image feature of the test images with the feature of the reminder image,
selecting amongst the test images, at least one subset of images whose image feature is closest to the reminder image.

8) The method according to claim 6, wherein the image feature is at least one feature amongst the capture time/date of images, a semantic content of the images, preset metadata attached to the images.

9) The method according to claim 1, wherein the similarity computation comprises an ordering of the images in the image collection and the selection of a range in the ordered images.

10) The method according to claim 1, wherein step d) is triggered by any user interaction with the first interface.

11) The method according to claim 1, wherein step f) is carried out either in response to a user reset input or automatically after a predetermined period if no user input is detected either on the first or the second user interface.

12) The method according to claim 1, further comprising a selection step allowing a user to select an image processing device to which the data of the selected linked image is to be sent to.

13) The method according to claim 1, further comprising repeating steps b) and d) with at least one additional automatically selected subset of linked images, upon user request.

14) A digital photo frame comprising, a user interface, a display screen for displaying the reminder images and the selected subset of images and a processing unit running software instructions for performing the method according to claim 1.

15) The photo frame according to claim 14 wherein the user interface is a touch screen.
